(19) United States
(12) Patent Application Publication
(10) Pub. No.: US 2010/0103135 A1
(43) Pub. Date: Apr. 29, 2010

(54) Mobile Apparatus

(76) Inventor: Hiroto Sugahara, Aichi-ken (JP)

Correspondence Address: FROMMER LAWRENCE & HAUG, 745 FIFTH AVENUE- 10TH FL., NEW YORK, NY, 10151, US

(21) Appl. No.: 12/606,583

(22) Filed: Oct. 27, 2009

(30) Foreign Application Priority Data
Oct. 27, 2008 (JP) 2008-275256

(51) Int. Cl. G06F 3/041; H04M 1/00; G08B 6/00

(52) U.S. Cl. 345/173; 455/550.1; 340/407.2

(57) ABSTRACT

A mobile apparatus which includes a casing, an input mechanism, a force-sense generating mechanism provided in the casing and giving the user a force-sense of a translational force toward a first direction, and a controller which controls the force-sense generating mechanism based on the input operation information from the input mechanism and which gives the user translational forces toward one side and the other side of the first direction alternately to thereby present one of positive response information and negative response information with respect to the input operation information to the user through the force-sense. Accordingly, when presenting information from a device side to the user, the user can understand the information intuitively.

### CROSS REFERENCE TO RELATED APPLICATION

The present application claims priority from Japanese Patent Application No. 2008-275256, filed on Oct. 27, 2008, the disclosure of which is incorporated herein by reference in its entirety.

### BACKGROUND OF THE INVENTION

1. Field of the Invention

The present invention relates to a mobile apparatus that a user can carry such as, for example, a portable inkjet printer, a mobile telephone, a handset of a landline telephone, a digital still camera, a digital video camera, a portable video game console, a portable audio player, a controller of a stationary type video game console, or a TV remote controller.

2. Description of the Related Art

Such a mobile apparatus is provided with a display device such as a liquid crystal panel, or is provided with a speaker, and can present various types of information to a user by these devices by appealing to a sense of sight or a sense of hearing. Further, it is also proposed that a device operating to give a user a pseudo-force-sense as if a translational force is being generated in a casing is used, thereby presenting information to the user by appealing to a sense of force (refer to, for example, Japanese Patent Application Laid-open Nos. 2008-28774, and 2006-65665).

As described above, presenting information to a user by appealing to not only senses of sight and hearing but also a sense of force enables the user to understand the information more intuitively, so that it becomes effective for a user who is not accustomed to handling an electronic device in particular. Accordingly, in recent years, there have been required a method to present information from a device to a user intuitively and a provision of a mobile apparatus configured to present such information accurately.

### SUMMARY OF THE INVENTION

Thus, when presenting information from a device to a user, the present invention has an object to provide a mobile apparatus configured to enable the user to understand the information intuitively.

The present invention has been made in view of such circumstances, and according to an embodiment of the present invention, there is provided a mobile apparatus which is carriable by a user, including:

a casing;

an input mechanism provided on the casing through which input-operation information is input;

a force-sense generating mechanism which is provided in the casing and which gives the user a force-sense of a translational force in a first direction; and

a controller which controls the force-sense generating mechanism based on the input-operation information input from the input mechanism and which alternately gives the user translational forces toward one side and the other side of the first direction to present to the user, through the force-sense, one of positive response information and negative response information with respect to the input operation information.

With the above configuration, by using the force-sense generating mechanism, response information of a device to an input operation can be presented by appealing to a force-sense, and thereby a determination of the device to the input operation that the user him/herself performs can be understood intuitively. Note that in a use state of the user, a front face of the casing may be a face where the user faces, and a lateral direction may be a right and left direction seen from the user. With the above configuration, the user can recognize an association of the positive response information and the negative response information with the direction of the force-sense given by the force-sense generating mechanism without making mistakes.

As described above, according to the present invention, when presenting information from a device to a user, the user is enabled to understand the information intuitively.

### BRIEF DESCRIPTION OF THE DRAWINGS

FIG. 1 is a front view of a mobile telephone shown as an example of an embodiment of a mobile apparatus according to the present invention;

FIG. 2 is a block diagram functionally showing a configuration of the mobile telephone shown in FIG. 1;

FIG. 3 is a schematic cross-sectional view of the mobile telephone showing an essential portion of an internal structure of the mobile telephone shown in FIG. 1;

FIG. 4 is a schematic cross-sectional view of the mobile telephone shown, taken along IV-IV line in FIG. 3;

FIG. 5 is a timing chart explaining a basic operation of a force-sense generating device of the mobile telephone shown in FIG. 3;

FIG. 6A and FIG. 6B are explanatory views of the basic operation of the first force-sense generating device of the mobile telephone shown in FIG. 3, and FIG. 6A shows a state where a positive acceleration is generated in a first weight in the first force-sense generating device and FIG. 6B shows a state where a negative acceleration is generated in the first weight respectively;

FIG. 7 is a view explaining force-senses to be given to a user holding a casing by using the force-sense generating devices shown in FIG. 3 and FIG. 4;

FIG. 8 is a flow chart explaining one example of control contents that a main control section of the mobile telephone shown in FIG. 2 executes;

FIG. 9A is a view showing one example of preferable dispositions of two force-sense generating devices when a casing is in a box shape, FIG. 9B is a view showing one example of preferable dispositions of two force-sense generating devices in the case when a display device is provided on a front face of the casing, and FIG. 9C is a view showing a more preferable example; and

FIG. 10A is a view showing a head mounted display as one example of the present invention, and FIG. 10B is a view showing a head mounted display to which a head arm is attached.

### DETAILED DESCRIPTION OF THE PREFERRED EMBODIMENTS

Hereinafter, embodiments according to the present invention will be explained with reference to the attached drawings.

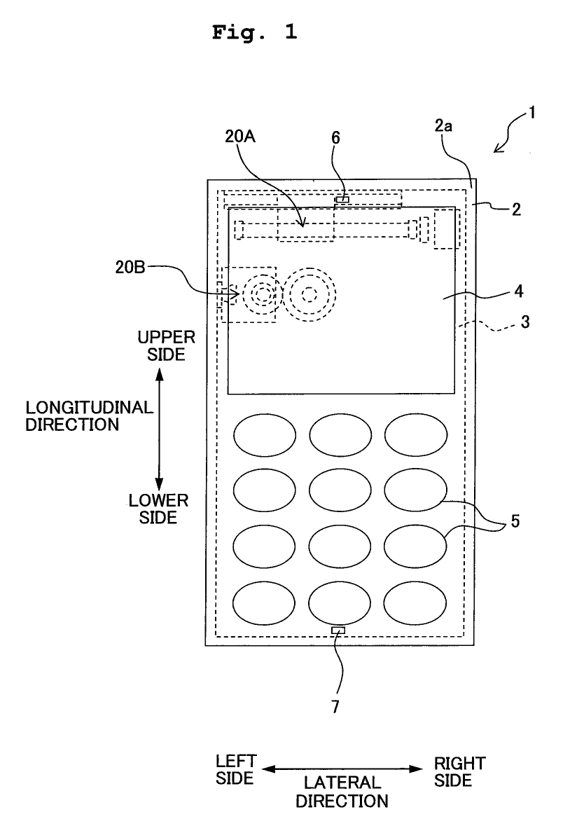

As shown in FIG. 1, a mobile telephone 1 is provided with a casing 2 in a substantially rectangular parallelepiped shape, and in an inner space 3 of the casing 2, two force-sense generating devices 20A, 20B (a force-sense generating mechanism) operating to give force-senses to a user holding the casing 2 are provided.

In the following explanation, as long as it is not mentioned in particular, the directions of the mobile telephone 1 are defined based on directions seen from the user who uses this mobile telephone 1. Note that “use state” indicates the state where the user uses the mobile telephone 1 in a regular posture recommended by, for example, a manual.

A display device 4 such as a liquid crystal panel is provided at an upper portion on a front face 2a of the casing 2, and a plurality of push buttons for an input operation are provided at a lower portion on the front face 2a. A speaker 6 is provided at an upper end portion on the front face 2a, and a microphone 7 is provided at a lower end portion on the front face 2a. It is general that in the use state of the mobile telephone 1, the user turns the front face 2a shown in the drawing toward the user him/herself to face to the display device 4 functioning as a device presenting various types of information by appealing to a sense of sight, and further holds the lower portion of the casing 2 not to cover the display device 4 by the user's hand and further to press the push buttons 5 for an input operation easily.

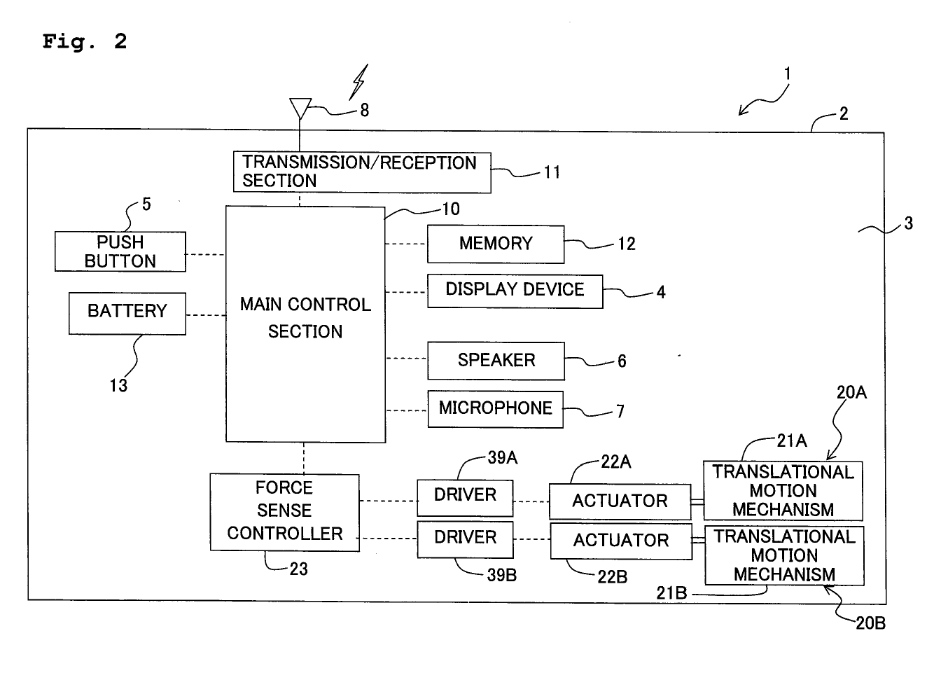

As shown in FIG. 2, a main control section 10 integrally controlling operations of the mobile telephone 1 is provided in the inner space 3 of the casing 2. The main control section 10 is connected to the display device 4, and enables the display device 4 to display image information appropriately. The main control section 10 is connected to the push buttons 5, and is configured so that an operation signal is input when the push buttons 5 are pressed.

The main control section 10 is connected to the speaker 6 and the microphone 7, and is also connected to an antenna 8 via a transmission/reception section 11. At the time of a telephone conversation, the transmission/reception section 11 demodulates a reception frequency signal received from a base station via the antenna 8 to output the demodulated signal to the main control section 10, and the main control section 10 processes the signal from the transmission/reception section 11 to output the processed signal to the speaker 6. On the other hand, the main control section 10 processes an audio signal from the microphone 7 to output the processed signal to the transmission/reception section 11, and the transmission/reception section 11 modulates the signal from the main control section 10, and then converts the modulated signal into a transmission high frequency signal to transmit it to the antenna 8. Further, the main control section 10 is connected to a memory 12 storing various types of information and a battery 13 being a power source.

Further, the main control section 10 is connected to a force-sense controller 23 of the force-sense generating devices 20A, 20B, and the main control section 10 controls operations of the force-sense generating devices 20A, 20B to give force-senses in predetermined acting directions to the user by providing commands to the force-sense controller 23.

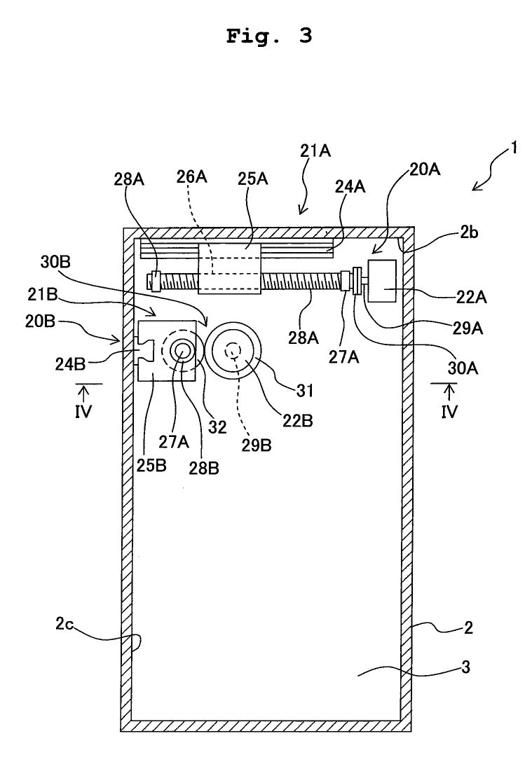

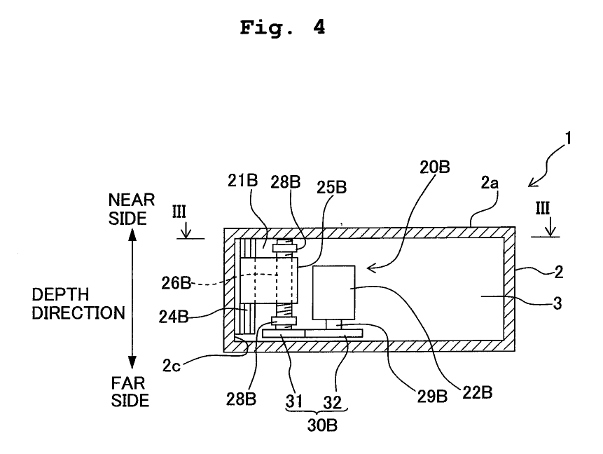

Next, configurations of the force-sense generating devices 20A, 20B will be explained. As shown in FIGS. 3 and 4, the two force-sense generating devices 20A, 20B are disposed in the inner space of the casing 2. The respective force-sense generating devices 20A, 20B include translational motion mechanisms 21A, 21B disposed in the inner space 3 of the casing 2, actuators 22A, 22B driving the translational motion mechanisms 21A, 21B, and the force-sense controller 23 (refer to FIG. 2) controlling operations of the actuators 22A, 22B. As described above, the force-sense controller 23 (refer to FIG. 2) is single, and is provided to be common to the two force-sense generating devices 20A, 20B.

On the other hand, the translational motion mechanisms 21A, 21B and the actuators 22A, 22B are provided corresponding to the force-sense generating devices 20A, 20B respectively. The translational motion mechanism 21A and the actuator 22A configuring the force-sense generating device 20A on one side are attached to an inner upper surface 2b defining the inner space 3 of the casing 2, and the translational motion mechanism 21B and the actuator 22B configuring the force-sense generating device 20B on the other side are attached to an inner side surface 2c defining the inner space 3 of the casing 2. Hereinafter, explanation will be conducted in a manner that “first” is appropriately added to components related to the former and “second” is appropriately added to components related to the latter.

As shown in FIG. 3, a first guide rail 24A attached to the inner upper surface 2b and extending in a lateral direction is provided in the first translational motion mechanism 21A. In the first guide rail 24A, a first weight 25A is supported such that the first weight 25A is non-rotatable but slidable, and that the first weight 25A can reciprocate in the lateral direction in an upper region in the inner space 3 of the casing 2. A female screw hole 26A is formed through the first weight 25A, and an axis of the female screw hole 26A is turned toward the lateral direction in the state of the first weight 25A being supported in the first guide rail 24A. A first ball screw 27A in which male threads are formed on its outer surface is screwed into this female screw hole 26A, and the first ball screw 27A is supported such that the first ball screw 27A is rotatable by bearings 28A attached inside the casing 2 but is immovable in a rotation axis direction.

The first actuator 22A includes an electric motor such as, for example, a servomotor or a linear motor. An output shaft 29A rotatable in both forward and reverse directions (CW direction and CCW direction) is provided in the first actuator 22A, and the output shaft 29A is connected to an end portion of the first ball screw 27A via a joint 30A. When this first actuator 22A is driven, the output shaft 29A rotates and a rotary driving force from the output shaft 29A is input to the first ball screw 27A, and the first ball screw 27A is driven to rotate in a predetermined direction. When the first ball screw 27A which is immovable in an extending direction of the first guide rail 24A rotates, the first weight 25A, which is not rotatable in the rotational direction and in a helical direction of the first ball screw 27A, moves linearly in the extending direction of the first guide rail 24A.

As shown in FIG. 4, the second translational motion mechanism 21B also has substantially the same configuration as that of the first translational motion mechanism 21A. Then, a second guide rail 24B is attached to an upper portion on the inner side surface 2c to extend in a depth direction, and a second weight 25B supported in this second guide rail 24B can reciprocate in the depth direction in the upper region in the inner space of the casing 2. A second ball screw 27B is screwed into a female screw hole 26B formed in the second weight 25B, and the second ball screw 27B is supported such that the second weight 25B is rotatable by bearings 28B but is not immovable in the depth direction (in a rotation axis direction). Note that in the casing 2 of the mobile telephone 1, a dimension of the depth direction (namely a thickness direction) is relatively small, so that it is relatively difficult to dispose the second actuator 22B and the second ball screw 27B coaxially similarly to those of the first force-sense generating device 20A extending in the lateral direction.

Therefore, the second actuator 22B is arranged to be shifted toward a left side with respect to the second translational motion mechanism 21B, and an output shaft 29B of the second actuator 22B protrudes from a main body of the second actuator 22B toward a far side. A parallel gear arrangement 30B is interposed between this output shaft 29B and an end portion of the second ball screw 27B on the far side. This parallel gear arrangement 30B is provided with a drive gear 31 fixed to the output shaft 29B and a driven gear 32 fixed to the second ball screw 27B, and these two gears 31, 32 engage with each other. When the second actuator 22B is driven, the output shaft 29B rotates and a rotary driving force of the output shaft 29B is transmitted to the second ball screw 27B via the parallel gear arrangement 30B. When the second ball screw 27B which is immovable in the depth direction rotates, the second weight 25B, which is incapable of rotating in a rotation direction and a helical direction of the second ball screw 27B, moves linearly in the depth direction.

As shown in FIG. 2, the force-sense controller 23 is connected to the actuators 22A, 22B via drivers 39A, 39B, and outputs control commands to the drivers 39A, 39B to control rotation directions, rotational velocities, and rotational accelerations of the output shafts 29A, 29B in the actuators 22A, 22B. According to the above, the rotation directions, rotational velocities, and rotational accelerations of the ball screws 27A, 27B in the translational motion mechanisms 21A, 21B shown in FIGS. 3 and 4 are controlled. As a result, positions, moving directions, velocities, and accelerations of the weights 25A, 25B are controlled.

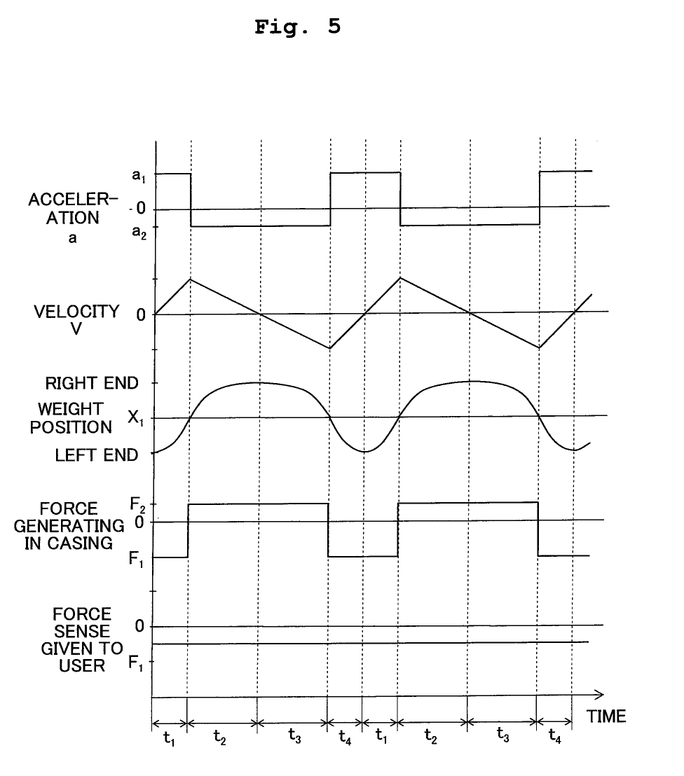

Next, with reference to FIG. 5, basic operations of the force-sense generating devices 20A, 20B will be explained by focusing attention on an operation of the first weight 25A in the first force-sense generating device 20A. For convenience of this explanation, the direction in which the first weight 25A reciprocates is defined as “a lateral direction”, and the velocity when the first weight 25A moves to the right side is defined as positive, and the velocity when the first weight 25A moves to a side opposite to the above is defined as negative. With regard to the acceleration generated in the first weight 25A and a force acting based on this acceleration, positive/negative is determined in a similar manner as described above.

In an initial state, it is assumed that the first weight 25A is positioned at a left end in a movable range and that a velocity V of the first weight 25A is 0. As shown in FIG. 3, when the first weight 25A moves linearly rightward from this initial state, a positive acceleration a1 is generated in the first weight 25A and the velocity V of the first weight 25A is accelerated. When a predetermined time t1 passes after this first weight 25A starts moving, the first weight 25A reaches a predetermined position x1 (a middle position in the movable range in FIG. 5 shown as an example), and thereafter a negative acceleration a2 is generated in the first weight 25A and the velocity V of the first weight 25A is decelerated. When a predetermined time t2 passes after the acceleration a turns to be negative, the velocity V of the first weight 25A becomes 0 and then the first weight 25A is positioned at a right end in the movable range. Subsequently, a negative acceleration a2 is generated in the first weight 25A, and the first weight 25A moves leftward while accelerating the velocity V to a negative side. When a predetermined time t₃ passes after the moving direction of the first weight 25A turns leftward, the first weight 25A reaches the above-described predetermined position x1, and thereafter the positive acceleration a1 is generated in the first weight 25A and the velocity V of the first weight 25A is decelerates. When a predetermined time t₄ passes after the acceleration a turns to be positive, the velocity V of the first weight 25A becomes 0 and the first weight 25A returns to the left end in the movable range. The force-sense generating device 20A is configured so that a series of reciprocations of the first weight 25A, which is described above, is performed continuously.

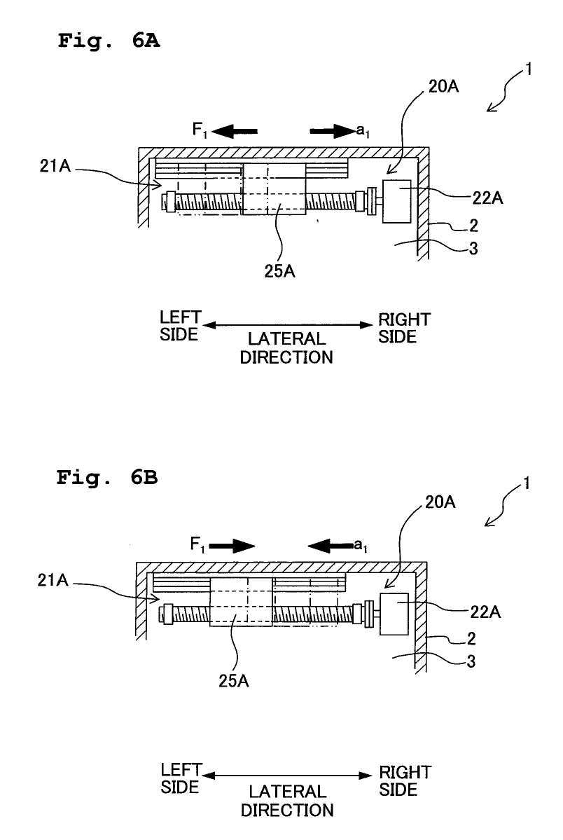

As shown in FIG. 6A, when the positive acceleration a1 is generated in the first weight 25A, a negative (leftward) force F1 is generated in the casing 2 by a reaction of the above, and a leftward translational force in accordance with this force F1 acts from the casing 2 to a palm of the user holding the casing 2. As shown in FIG. 6B, when the negative acceleration a2 is generated in the first weight 25A, a positive (rightward) force F2 is generated in the casing 2, and a rightward translational force in accordance with this force F2 acts from the casing 2 to the palm of the user holding the casing 2. When mass of the first weight 25A is set as M, the forces F1, F2 shown in FIGS. 6A and 6B respectively can be obtained by the following equations of motion: F1=M·(−a1), F2=M·(−a2) respectively.

As shown in FIG. 5, an absolute value of the positive acceleration a1 is larger than that of the negative acceleration a2, and an absolute value of the negative force F1 is larger than that of the positive force F2 (|a|>|a2|, |F1|>|F2|). The force-sense controller 23 is configured to control the rotational velocity and the rotational acceleration of the output shaft 29A so that the operation of this first weight 25A can be achieved. Accordingly, two asymmetrical forces having different sizes continue to act to the user alternately.

Here, a human being possesses a perceptual property in which a human being becomes insensitive to a gentle force. The point on which the perceptual property of a human being has a nonlinearity as described above is well-known (refer to, for example, Japanese Patent Application Laid-open Nos. 2008-28774, 2006-65665), and a detailed explanation with regard to the above point is omitted in the present application.

As a result, the user under such a circumstance has an illusion that only the leftward translational force being a strong force is acting as shown by the chart at the lowest part in FIG. 5 due to the perceptual property of the user him/herself. In other words, when the first weight 25A reciprocates continuously, the first force-sense generating device 20A drives the first actuator 22A such that the absolute value of the positive acceleration differs from the absolute value of the negative acceleration which are generated in the first weight 25A. As a result, it is possible to give the user holding the casing 2 a pseudo-force-sense as if the translational force toward either side of the lateral direction being the moving direction of the first weight 25A acts from the casing 2.

Similarly, in the second force-sense generating device 20B as well, positive and negative accelerations to be generated in the second weight 25B are made different, and thereby a pseudo-force-sense as if a translational force toward either side of the depth direction being the reciprocation direction of the second weight 25B acts from the casing 2 can be given to the user holding the casing 2.

Typically, the masses of the first and second weights 25A, 25B are approximately 20 g, and strokes of the reciprocations and sizes of the accelerations of the first and second weights 25A, 25B are approximately 5 to 10 cm, and approximately 1 to 5 G, respectively. Further, frequencies of the reciprocations of the first and second weights 25A, 25B are several hertz to ten odd hertz, and are preferable to be approximately 10 Hz in particular. Note that the masses of the first and second weights 25A, 25B and the strokes, accelerations, and frequencies of the reciprocations of the first and second weights 25A, 25B, and so on are not limited to this example, but may be set in accordance with a size of the casing 2, sizes of the translational forces to be generated, and so on. Further, the masses of the first and second weights 25A, 25B may be different from each other, but it is desirable that they are the same.

Note that an operational pattern of the weight shown in FIG. 5 is an example, and can be modified appropriately within a range where this pseudo-force-sense can be given to the user. For example, when the absolute value of the negative acceleration is set larger than that of the positive acceleration, the direction of the translational force that the user senses in a pseudo manner becomes an opposite side. Further, the pattern in which the velocity V varies linearly is shown as an example in order to simplify the explanation, but it may be configured so that the velocity V varies nonlinearly and the absolute value of the positive acceleration and/or the absolute value of the negative acceleration vary/varies as the time passes. At this time, the weight may be reciprocated such that a maximum value of the absolute value of the positive acceleration which is generated in the weight is different from a maximum value of the absolute value of the negative acceleration. The position x1 of the weight at which the sign of the acceleration a change is not limited to the middle position in the movable range but can also be appropriately modified, and the time required for the reciprocating operation of the weight (t₁+t₂+t₃+t₄) can also be set to an appropriate value.

Further, the configurations of the force-sense generating devices 20A, 20B shown in FIGS. 3 and 4 can also be modified appropriately. The translational motion mechanisms 21A, 21B are configured to convert the rotary driving forces that the actuators 22A, 22B generate into translational motions of the weights 25A, 25B by using a screw mechanism. However, any mechanism may be applied as long as the weights 25A, 25B can be reciprocated by making the positive and negative accelerations different. For example, a translational motion mechanism 5 may have a linear motor, or have a pulley and a belt interlocking with a motor.

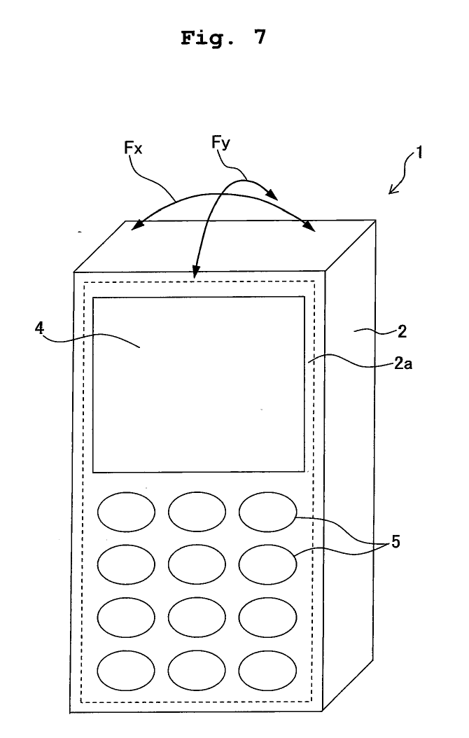

As shown in FIG. 7, it is general that in the use state, the user makes the front face 2a where the display device 4 and the push buttons 5 are provided face to the user him/herself, and holds the lower portion of the casing 2, where the display device 4 is not provided but the push buttons 5 are provided.

On the other hand, the first and second force-sense generating devices 20A, 20B are disposed in the upper region in the inner space 3 of the casing 2. Therefore, when the first force-sense generating device 20A is driven, the pseudo-force-sense as if the upper portion of the casing 2 tilts right and left (refer to arrows Fx) is given to the user holding the lower portion of the casing 2. Further, when the second force-sense generating device 20B is driven, the pseudo-force-sense as if the upper portion of the casing 2 tilts in the depth direction (refer to arrows Fy) is given to the user holding the lower portion of the casing 2.

Here, when an orientation of the acting direction of the force-sense is changed as shown by the arrows Fx, with regard to the accelerations generated in the first weight 25A, a first situation in which the absolute value of the positive acceleration is made larger than that of the negative acceleration and a second situation in which the above situation is reversed may be changed alternately every predetermined time (in the present specification, a symbol “T” is added to this predetermined time as a matter of convenience for the explanation). Note that it is necessary to secure this predetermined time T long to a certain extent in order to give the user the force-sense as if the upper portion of the casing 2 shakes right and left by changing the orientation of the acting direction of the force-sense right and left as described above.

This embodiment is configured so that when the translational force is generated in the casing by the reciprocation of the weight and the force-sense in accordance with the translational force is given to the user, the accelerations of the weight are made different in the positive and negative, and thereby the user feels as if the translational force acts in a pseudo manner. In other words, even when a cycle of the reciprocation of the weight is made short, it is not affected at all in order to secure the above-described predetermined time T. Therefore, the accelerations to be generated in the weight can be made large, so that it is possible to make the mass of the weight small in order to give the user the translational force having a desired size.

Next, there will be explained a control in which the first and second force-sense generating devices 20A, 20B present information to the user holding the casing 2 by appealing to the force-sense, with reference to the case when the user registers telephone directory information in the memory 12 of the mobile telephone 1 as an example. When registering the telephone directory information as above, telephone number information can be stored in association with various types of information such as a name, but the explanation will be conducted here in a manner that only the telephone number information is registered for simplification of the explanation. The user can input this telephone number information by pressing the push buttons 5. At this time, in general, the user holds the lower portion of the casing 2, which is the side where the push buttons 5 are disposed, in order to perform the pressing operation easily.

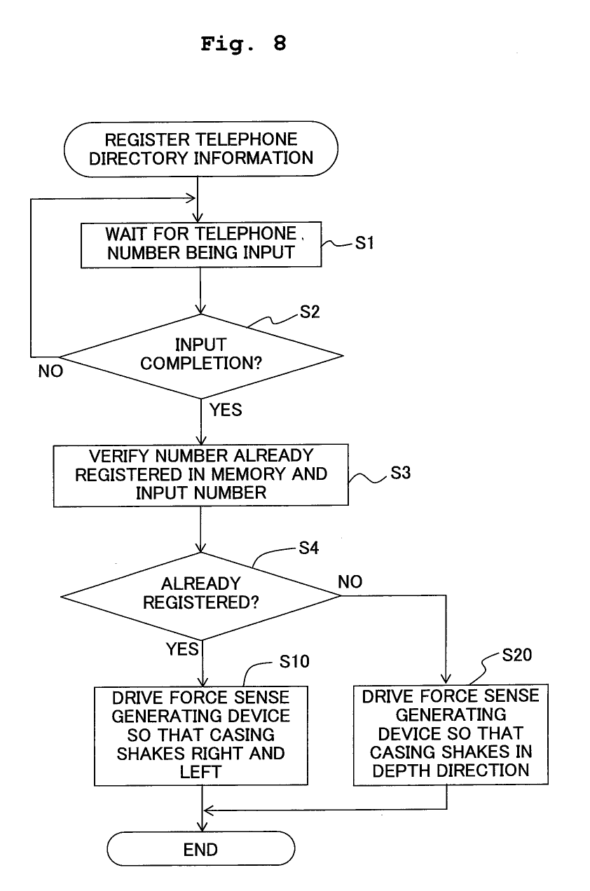

As shown in FIG. 8, when the mobile telephone 1 is brought into a control mode for registering the telephone directory information, the main control section 10 turns to a state of waiting for a telephone number being input (Step S1), and then determines whether or not the input is completed (Step S2). In the case when the input is not completed (S2: NO), the main control section 10 returns to Step 1 to maintain the state of waiting until the input is completed. In the case when the input is completed (S2: YES), the main control section 10 verifies the input telephone number and telephone directory information previously stored in the memory 12 (Step 3), as a result of the verification, it is determined whether or not the input telephone number is overlapped with the telephone directory information previously registered (Step 4).

In the case when the telephone number is the one that is previously registered (S4: YES), the main control section 10 drives the first force-sense generating device 20A to give the user holding the lower portion of the casing 2 the force-sense as if the upper portion of the casing 2 tilts in the lateral direction. At this time, the main control section 10 changes the acting direction of the force-sense given to the user every predetermined time so that the force-sense shown by the arrows Fx in FIG. 7 can be given to the user. In other words, the first situation in which the absolute value of the positive acceleration is made larger than that of the negative acceleration to reciprocate the first weight 25A and the second situation in which the above first situation is reversed to reciprocate the first weight 25A are generated alternately every predetermined time. Accordingly, the force-sense as if the casing 2 has its head shaking right and left is given to the user, and the user intuitively understands that the telephone number input this time is unnecessary to be registered newly as the telephone directory information, namely the device presents negative response information to the input command that the user him/herself performs.

The main control section 10 stops the operation of the first force-sense generating device 20A after changing the acting direction of the force-sense given to the user based on the operation of the first force-sense generating device 20A several times.

On the other hand, in the case when the telephone number is a new one that is not registered in the memory (S4: NO), the main control section 10 drives the second force-sense generating device 20B to give the user holding the lower portion of the casing 2 the force-sense as if the upper portion of the casing 2 tilts in the depth direction. At this time, the main control section 10 changes the acting direction of the force-sense given to the user every predetermined time so that the force-sense shown by the arrows Fy in FIG. 7 can be given to the user. Accordingly, the force-sense as if the casing 2 nods is given to the user, and the user recognizes that the telephone number input this time is newly registered as the telephone directory information, namely the user intuitively understands that the device presents positive response information to the input command that the user him/herself performs.

Note that the reason why the force-sense shown by the arrows Fx is recognized as the negative response information for the user and the force-sense shown by the arrows Fy is recognized as the positive response information for the user is that the user uses the mobile telephone 1 in the regular posture facing to the front face 2a of the casing 2. As long as the user uses the mobile telephone 1 in the regular posture, there is little fear that the negative response information is erroneously recognized as the positive response information. Further, providing the display device 4 on the front face 2a of the casing 2 leads the user to face to the front face 2a of the casing 2, and thereby a possibility of the mobile telephone 1 being used in the regular posture is enhanced. Accordingly, a possibility that the negative response information and the positive response information are erroneously recognized is further reduced.

The main control section 10 stops the operation of the second force-sense generating device 20B after changing the acting direction of the force-sense given to the user based on the operation of the second force-sense generating device 20B several times.

Hereinbefore, the embodiment according to the present invention is explained, but the above-described configuration can be appropriately modified within the range of the present invention. In particular, at which scene the response information from the device is presented to the user by using the two force-sense generating devices is not limited to the above-described example but the presenting of the response information can be applied at various scenes.

Note that in the above-described embodiment, the two force-sense generating devices have the dedicated weights used only for performing the reciprocations to generate the force-senses. However, the present invention is not limited to the above, and for example, components incorporated in the casing for another use such as batteries may be used as the weights.

In the above-described embodiment, when reciprocating the weight in a predetermined direction, the force-sense generating device can provide the acceleration toward one side and the acceleration toward the other side asymmetrically. Here, an asymmetry of the acceleration toward one side and the acceleration toward the other side is reversed at regular time intervals, thereby giving the user the force-sense as if the casing shakes in the predetermined direction alternately. However, the present invention is not limited to the above, and for example, the acceleration toward one side of a predetermined direction and the acceleration toward the other side of the predetermined direction may be provided symmetrically. In the above case as well, the force-sense as if the casing shakes in the predetermined direction alternately can be given to the user. Note that in the above case, it is desirable that a cycle of the reciprocation of the weight is made shorter (typically, approximately several hertz) compared with that in the above-described embodiment.

In the above-described explanation, the two force-sense generating devices are provided in the mobile apparatus according to the present invention, but the present invention is not limited to the above. A single force-sense generating device or three or more force-sense generating devices may be provided in the mobile apparatus, and preferably, it is desirable that at least two force-sense generating devices are provided along different directions so that force-senses as if the casing shakes at least in two different directions can be given to the user.

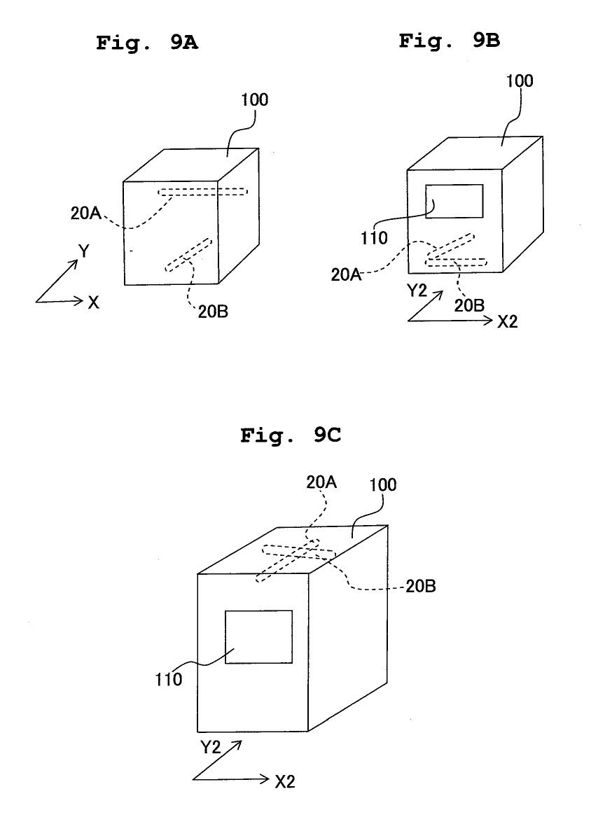

Here, two force-sense generating devices generating force-senses as if a casing shakes in two different directions (first and second directions) are cited as an example, and it is considered at which positions and in which directions of the casing the two force-sense generating devices are preferable disposed. For example, as shown in FIG. 9A, in the case of a casing 100 being in a box shape, it is desirable that the two force-sense generating devices are disposed along normal directions of two faces, which are not parallel to each other, of the casing. For example, the two force-sense generating devices may be disposed along a lateral direction X and a depth direction Y of the casing 100. Further, as shown in FIG. 9B, in the case when a display device 110 such as a liquid crystal display device is provided on one face (a front face) of the casing 100, it is desirable that the two force-sense generating devices are provided along a direction X2 parallel to the front face and a direction Y2 perpendicular to the front face. Further, in the case when a user is supposed to hold a lower portion of the casing 100, as shown in FIG. 9C, it is desirable in particular that the two force-sense generating devices are provided along the direction X2 parallel to the front face and the direction Y2 perpendicular to the front face on an upper portion of the casing 100. As described above, the force-sense generating devices are disposed away from the position where the user holds, so that force-senses that the user senses can be made large.

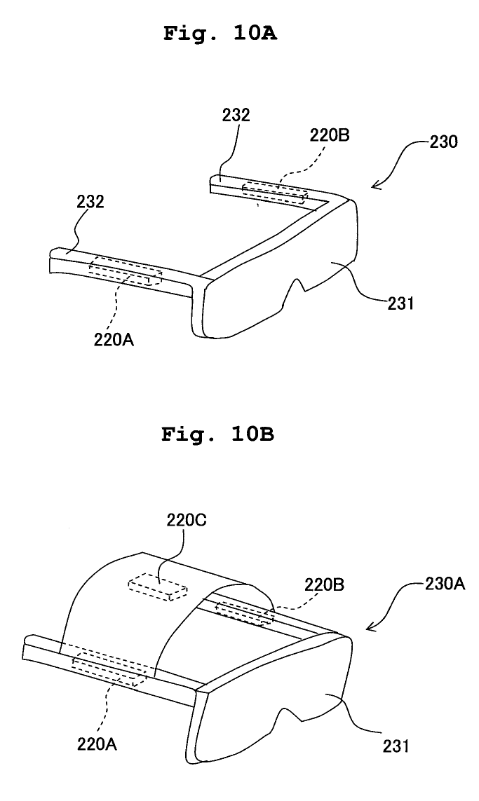

In the above-described embodiment, the case where the user holds the casing by the user's hand is explained as an example, but the present invention is not limited to the above. For example, as shown in FIG. 10A, it is also possible to apply the present invention to a spectacle type head mounted display 230. The head mounted display 230 has a display section 231 disposed at a position corresponding to spectacle lenses and covering user's eyes when a user puts on the head mounted display 230; and two frame rod sections 232 extending from the display section 231. When the user puts on the head mounted display 230, the two frame rod parts 232 extend to sandwich the user's temples, and hang on the user's ears. Here, force-sense generating devices 220A, 220B similar to those described above are incorporated in the two frame rod sections 232. Further, in the head mounted display 230, a sound input mechanism that is not shown in the drawing is provided as an input mechanism for receiving a command input from the user who puts on the head mounted display 230. Alternatively, as an input mechanism, a motion detection mechanism (an acceleration sensor) detecting movements in which the user shakes his/her head horizontally and vertically may be provided therein.

Here, for example, there is considered the case when a user putting on the head mounted display 230 to view images on DVD performs an operation to switch to a menu screen. When the user inputs a command of “display menu screen” by sound (voice), in the case when it is possible to display the menu screen, the head mounted display 230 switches the image to the menu screen and the force-sense generating devices 220A, 220B give the user a force-sense as if they shake a head part of the user putting on the head mounted display 230 back and forth. Then, in the case when the switching operation to the menu screen is prohibited, such as the case of being in the middle of a preview, for example, the force-sense generating devices 220A, 220B give the user a force-sense as if they shake the user's head right and left.

Concretely, as shown in FIG. 10A, the two force-sense generating devices 220A, 220B are disposed along extending directions of the two frame rod sections 232. The two force-sense generating devices 220A, 220B are in phase with each other and alternately provide translational forces to a front (a display section 231 side) and rear sides of the extending directions thereby being able to give the user the force-sense as if they shake the user's head back and forth (response display of YES). Further, the two force-sense generating devices 220A, 220B are in reverse phase with each other and alternately generate force-senses of translational forces to the front (the display part 231 side) and rear sides of the extending directions thereby being able to give the user the force-sense as if they shake the user's head right and left (response display of NO).

Note that as shown in FIG. 10B, a head mounted display 230A may be configured so that it has a head arm section 233 covering a top of a user's head and connecting to two frame rod sections 232, and another force-sense generating device 220C is provided in the head arm section 233. Here, the force-sense generating device 220C is disposed parallel to two force-sense generating devices 220A, 220B, and can generate a force-sense parallel to force-senses of translational forces that the force-sense generating devices 220A, 220B generate. Here, in the case of giving the user a force-sense as if the user's head is shaken back and forth, in place of driving the force-sense generating devices 220A, 220B in phase with each other, or alternatively in addition to the above, the force-sense of translational forces may also be alternately generated to the front side and the rear side by driving the force-sense generating device 220C. In the above case, compared with the force-sense generating devices 220A, 220B, the force-sense generating device 220C is disposed at a position away from the user's neck thereby being able to provide the force-sense as if the user's head is shaken back and forth effectively.

As described above, according to the present invention, the operation and effect in which response information from a device responding to an input operation of a user is presented to the user by appealing to a force-sense, thereby enabling the information to be transmitted accurately are achieved. The present invention is suitably applied to not only the above-described mobile telephone or the head mounted display but also an electronic device that a user can carry such as a portable inkjet printer, a handset of a landline telephone, a digital still camera, a digital video camera, a portable video game console, a portable audio player, a remote controller of a stationary type video game console, or a remote controller of a television.

What is claimed is:

1. A mobile apparatus which is carriable by a user, comprising:
a casing;
an input mechanism provided on the casing through which input-operation information is input;
a force-sense generating mechanism which is provided in the casing and which gives the user a force-sense of a translational force in a first direction; and
a controller which controls the force-sense generating mechanism based on the input-operation information input from the input mechanism and which alternately gives the user translational forces toward one side and the other side of the first direction to present to the user, through the force-sense, one of positive response information and negative response information with respect to the input operation information.

2. The mobile apparatus according to claim 1, wherein the casing has a front face which faces the user straight when the user uses the mobile apparatus, and
the first direction is parallel to the front face.

3. The mobile apparatus according to claim 2, wherein when the user holds the casing to be faced to the front face of the casing, the first direction coincides with a right and left direction.

4. The mobile apparatus according to claim 2, wherein a display device is provided on the front face of the casing.

5. The mobile apparatus according to claim 1, wherein the force-sense generating mechanism includes a weight capable of reciprocating in the first direction, and
the controller controls the force-sense generating mechanism to reciprocate the weight such that an amplitude of a positive acceleration of the weight toward the one side of the first direction is different from an amplitude of a negative acceleration toward the other side, and that the force-sense generating mechanism selectively gives the user the force-sense of the translational forces toward the one side and the other side of the first direction.

6. The mobile apparatus according to claim 3, wherein the force-sense generating mechanism includes first and second force-sense generating mechanisms, and the first and second force-sense generating mechanisms provide force-senses of translational forces toward a lateral direction parallel to the front face of the casing and a normal direction of the front face, respectively.

7. The mobile apparatus according to claim 6, wherein the controller drives the force-sense generating mechanism to alternately give the user force-senses of translational forces toward one side and the other side of the normal direction of the front face when the controller presents the positive response information with respect to the input operation information to the user, and
the controller drives the force-sense generating mechanism to alternately give the user force-senses of translational forces toward one side and the other side of the lateral direction of the front face when the controller presents the negative response information with respect to the input operation information to the user.

8. The mobile apparatus according to claim 2, wherein the force-sense generating mechanism is disposed in an upper portion of the casing seen from the user in a use state.

9. The mobile apparatus according to claim 1, wherein the force-sense generating mechanism includes a first force-sense generating mechanism giving the user a force-sense of a first translational force which alternately acts toward the one side and the other side of the first direction, and a second force-sense generating mechanism giving the user a force-sense of a second translational force which alternately acts toward one side and the other side of a second direction intersecting with the first direction, and
the controller makes the first force-sense generating mechanism generate the force-sense of the first translational force when presenting the positive response information, and the controller makes the second force-sense generating mechanism generate the force-sense of the second translational force when presenting the negative response information.

10. The mobile apparatus according to claim 5, wherein the force-sense generating mechanism includes a ball screw extending in the first direction, a motor rotating the ball screw, and a guide rail disposed parallel to the ball screw and supporting the weight slidably, and
a screw hole engaging with the ball screw is formed in the weight, and the ball screw is screwed into the screw hole.

11. The mobile apparatus according to claim 1, wherein the mobile apparatus is a mobile telephone having a transmission/reception section transmitting and receiving by converting an audio signal including audio information into a high frequency signal, a microphone converting sound into the audio signal, and a speaker outputting sound based on an audio signal made by converting the high frequency signal received by the transmission/reception section.

12. The mobile apparatus according to claim 1, wherein the mobile apparatus is a head mounted display having a display section disposed to cover eyes of the user and displaying images and two frame rod sections extending from the display section and disposed to sandwich temples of the user; and
the force-sense generating mechanism includes two pieces of the force-sense generating mechanism, and the two force-sense generating mechanisms are disposed in the two frame rod sections respectively.
